(19) United States
(12) Patent Application Publication
(10) Pub. No.: US 2012/0191488 A1
(43) Pub. Date: Jul. 26, 2012

(54) Use of Location Aware Check-In by Visitors to Support Emergency Services

(75) Inventor: Jonathan Alperin, Mendham, NJ (US)

(73) Assignee: AVAYA INC., Basking Ridge, NJ (US)

(21) Appl. No.: 13/011,134

(22) Filed: Jan. 21, 2011

(51) Int. Cl. G06Q 10/00

(52) U.S. Cl. 705/5

(57) ABSTRACT

A previously unregistered visitor enters the site. Contact information associated with the visitor, such as the visitor's phone number(s), an email address of the visitor, emergency contacts of the visitor, and the like, are registered. Location information associated with the visitor, such as calendar information, duration of the visit, a check-in at the site, and the like are registered. The registered contact and location information are stored in an emergency database. An emergency, such as a 911 emergency (e.g., fire in the building) is detected. The visitor and/or another contact identified by the contact information are notified based on the location information. This allows entities to be able to provide the same emergency services for visitors as for regular employees.

### TECHNICAL FIELD

The system and method relates to emergency notification systems and more specifically to emergency notification systems that notify visitors at a site.

### BACKGROUND

Today, there is an increasing demand on enterprises to provide increased access to public safety services such as police, firefighters, and ambulances. Additional requirements placed on enterprises are that they must be responsible for the safety and well-being of not only their employees, but also visitors to their premises. This works well for employees because the enterprise has information about the employee, such as the employee's telephone number, office location, cellular telephone number, calendar activities, Global Positioning Satellite (GPS) information, and the like. Using this information, when an emergency situation occurs, the employee can be easily notified of the situation.

When a visitor enters a specific site, typically only information such as who is being visited and the company the visitor is from are tracked. This is typically done on paper or entered into some type of visitor database. This information is not coupled with any emergency systems, so locating and/or notifying visitors during emergency situations can be problematic at best. What is needed is a system that can couple visitor information with existing emergency notification systems to better meet the increasing demands on the enterprise.

### SUMMARY

The system and method are directed to solving these and other problems and disadvantages of the prior art. Additional features and advantages of the disclosure will be set forth in the description that follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The system and method are targeted to extend traditional emergency services to visitors at a site. A previously unregistered visitor enters the site. Contact information associated with the visitor, such as the visitor's phone number(s), an email address of the visitor, emergency contacts of the visitor, and the like are registered. Location information associated with the visitor, such as calendar information, duration of the visit, a check-in at the site, and the like are registered. The registered contact and location information are stored in an emergency database. An emergency, such as a 911 emergency (e.g., fire in the building) is detected. The visitor and/or another contact identified by the contact information are notified based on the location information. This allows entities to be able to provide the same emergency services for visitors as for regular employees.

The registration of visitor information can be accomplished automatically or based on the visitor's approval by an application that may be running on a communication device used by the visitor. Alternatively, the application may be running on a device, such as a kiosk or some other device. In addition, the contact information can be based on mined information from a social network or based on receiving a notification from the social network.

### BRIEF DESCRIPTION OF THE DRAWINGS

In order to describe the manner in which the above-recited and other advantages, features of the disclosure, and best mode can be obtained, a more particular description of the principles briefly described above will be rendered by reference to specific embodiments thereof, which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a block diagram of a first illustrative system for registering contact and location information about a visitor and notifying the visitor and/or another contact in an emergency based on the location information.

FIG. 2 is a block diagram of a second illustrative system for registering contact and location information about a visitor and notifying the visitor and/or another contact in an emergency based on the location information.

FIG. 3 is a flow diagram of a method for registering contact and location information about a visitor and notifying the visitor and/or another contact in an emergency based on the location information.

FIG. 4 is a flow diagram of a method for notifying visitors and/or emergency contacts based on different kinds of contact and location information.

### DETAILED DESCRIPTION

Some embodiments will be illustrated below in conjunction with an exemplary communication system. Although well suited for use with, e.g., a system using switch(es), server(s) and/or database(s), communications endpoints, etc., the embodiments are not limited to use with any particular type of communication system or configuration of system elements. Those skilled in the art will recognize that the disclosed techniques may be used in any communication application in which it is desirable to provide emergency services. These variations shall be discussed herein as the various embodiments are set forth.

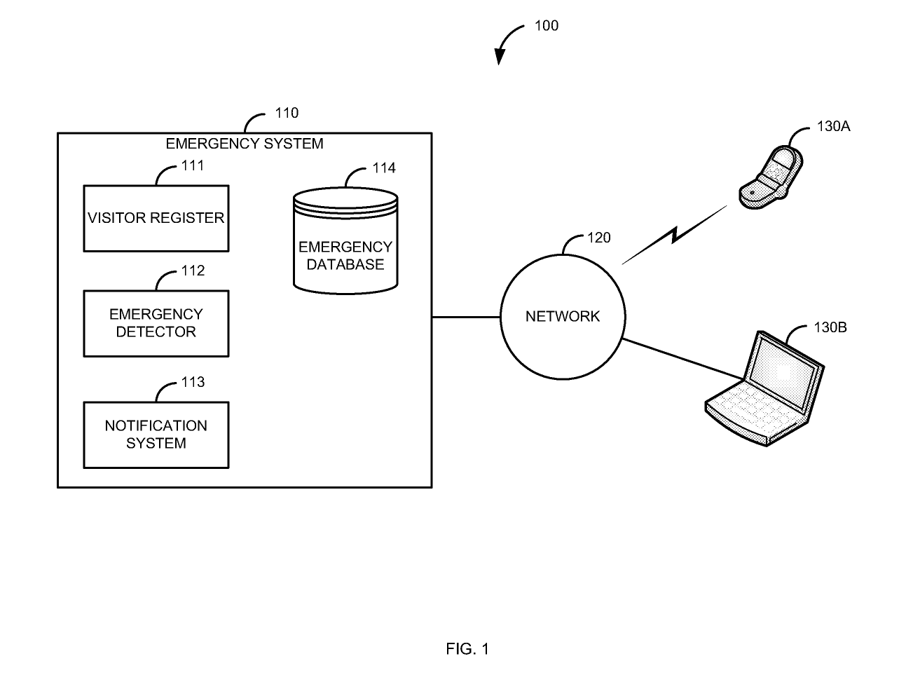

FIG. 1 is a block diagram of a first illustrative system 100 for registering contact and location information about a visitor and notifying the visitor and/or another contact in an emergency based on the location information. The first illustrative system 100 comprises emergency system 110, network 120, and communication devices 130A and 130B.

Emergency system 110 can be any device(s)/system(s) that can manage emergency services, such as a server, a software program, an embedded device, a Personal Computer (PC), and the like. Emergency system 110 further comprises visitor register 111, emergency detector 112, notification system 113, and emergency database 114. Visitor register 111 can be any hardware/software that can capture information associated with the visitor, such as a Personal Computer, a computer terminal, a bar code scanner, a Radio Frequency Identification (RFID) system, a card reader, a wireless interface, and the like. Emergency detector 112 can be any hardware/software that can detect and/or be notified of an emergency, such as a fire alarm system, an emergency 911 system, an email system, a telephone system, an alarm system, and the like. Notification system 113 can be any hardware/software that can provide notifications, such as a telephone system, a Private Branch Exchange (PBX), an email system, an Instant Messaging (IM) system, a pager system, and the like. Emergency database 114 can be any database that can store contact and/or location information, such as a relational database, a directory service, a file(s), an Extensible Mark-up Language (XML) file(s), and the like. Emergency database 114 can comprise multiple databases and/or can be distributed. Contact information can include information such as a name and/or phone number of the visitor, an email address of the visitor, an Instant Message (IM) address of the visitor, a name and/or phone number of a person at the site, an email address of a person at the site, an IM address of a person at the site, emergency contact(s) of the visitor, a list of allergies of the visitor, contacts for 911 responders, and the like. Location information can include information such as a duration of the visit (i.e., an indication that the visitor is on site during an emergency), calendar information of the visitor, calendar information of a person at the site, a Global Positioning Satellite (GPS) location of the visitor, a GPS location of a person at the site, a check-in by the visitor at a secondary, tertiary or alternate location at the site (indicating that the visitor is still on site), a wi-fi triangulation of where the visitor or person is at the site, and the like.

Network 120 can be any network, such as the Internet, a Local Area Network (LAN), a Wide Area Network (WAN), the Public Switched Telephone Network (PSTN), a corporate network, a combination of these, and the like. Communication devices 130A and 130B can be any type of communication device, such as a telephone, a cellular telephone, a Personal Digital Assistant (PDA), a Personal Computer (PC), a laptop computer, a notepad computer, and the like.

An unregistered visitor comes to a site. A site can be a campus, a group of buildings, a specific area, an individual building, and the like. An unregistered visitor is a visitor to the site that has not been previously registered or is no longer in emergency database 114. Prior to or during the visit, contact information and location information about the visitor are registered and stored in emergency database 114. The contact information contains contact information associated with the visitor and/or another contact (e.g., an emergency contact of the visitor). The location information contains location information associated with the visitor (i.e., typically location information about where the visitor is going to be during the visit to the site or if the visitor is at the site). The location information can contain location information about person(s) associated with the visitor, such as a location of the person who the visitor is meeting with. Contact information and location information can be registered in a variety of ways, such as providing the information to a security guard, via electronic means, and the like. Contact information and location information are typically temporary information that is stored/accessed for the duration of the time the visitor is at the site. For example, if the visitor is only going to be on site for a day, the contact information for that visitor can be removed from emergency database 114 after the visitor leaves. Likewise, the contact information can be added when the visitor checks in at a security desk and deleted when the visitor checks out at the security desk. After the visitor leaves, the contact information can remain in emergency database 114; however, access/use of the contact information will typically not occur when an emergency is detected by emergency detector 112 because the visitor is no longer at the site. Contact information and/or location information can be merged with other contact information in emergency database 114, such as contact information for emergency responders. Contact information and location information can be information that is from a corporate database or other emergency database that contains contact information about other corporate employees from different locations who are visiting the site.

Emergency detector 112 detects an emergency at the site. An emergency can be a fire, a terrorist threat, a weather emergency, a medical emergency, a bio-hazard, a flood, and the like. The emergency can be detected in various ways, such as detecting an alarm, receiving a notification from an emergency service (i.e., police/fire/911), an emergency call to security, and the like. Notification system 113 notifies the visitor or other contact based on the contact information and the location information.

For illustrative purposes, consider the following example. A visitor named Jon enters the campus for company XYZ to visit his friend Sam. Jon registers his contact information and location at company XYZ during check-in by providing his name (contact information), cellular telephone number (contact information), and that he is meeting Sam in his office from 1:00 P.M. to 3:00 P.M (location information). Jon's contact information and location information are stored in emergency database 114.

Emergency detector 112 detects at 2:00 P.M. that there is a fire in the building where Sam's office is located. Notification system 113 notifies Jon (because Jon's location information indicated that he is in Sam's office from 1:00 P.M. to 3:00 P.M.) that there is a fire by calling Jon's cellular telephone (communication device 130A). If Jon cannot be contacted on his cellular telephone 130A, notification system 113 can alternatively notify Jon via Sam's communication device 130B in his office because Jon's location information indicated that he was meeting with Sam in Sam's office during the time of the emergency.

The above example describes the use of phone numbers for contacting a visitor at a site. Similarly, other mediums of contact, such as email, Instant Messaging (IM), text messages, and the like, can be used to contact the visitor to the site.

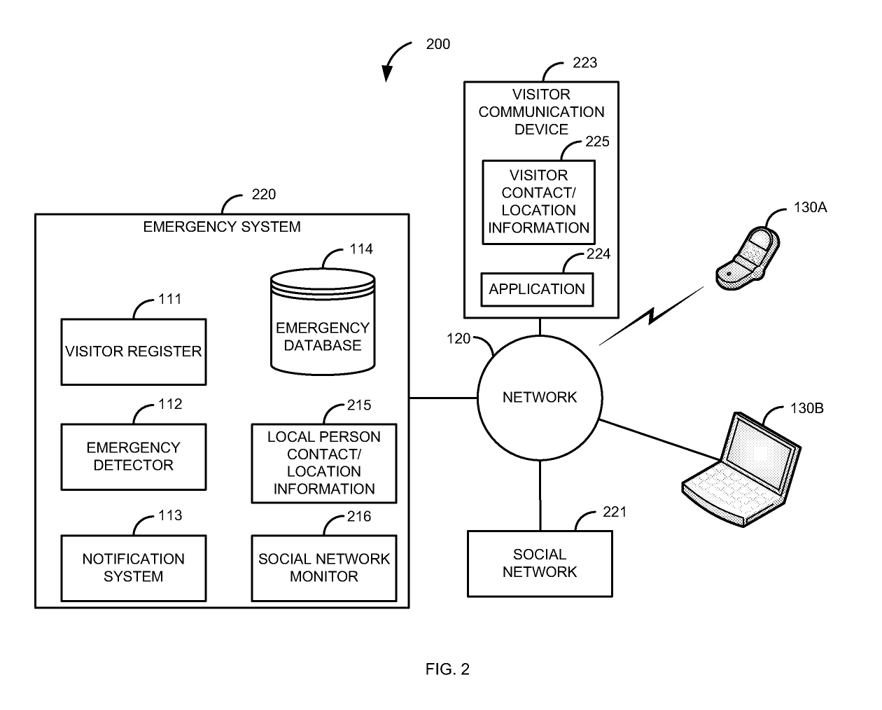

FIG. 2 is a block diagram of a second illustrative system 200 for registering contact information and location information about a visitor and notifying the visitor and/or another contact in an emergency based on the location information. The second illustrative system 200 comprises emergency system 220, network 120, communication devices 130A and 130B, social network 221, and visitor communication device 223.

Emergency system 220 further comprises visitor register 111, emergency detector 112, notification system 113, emergency database 114, local person contact/location information 215, and social network monitor 216. Local person contact/location information 215 can be any information/database that can comprise calendar or other location information (e.g., office locations) about person(s)/employees who reside at the site. Social network monitor 216 can be any hardware/software that can monitor social network 221 for changes or notifications about visitor(s).

Social network 221 can be any type of social network such as Facebook™, LinkedIn™, a blog site, a Really Simple Syndication (RSS) feed, Twitter™, and the like. Visitor communication device 223 further comprises visitor contact/location information 225, and application 224. Visitor contact/location information 225 can be any information/database that comprises information about visitor(s) to the site, such as calendar information, Global Positioning Satellite (GPS) coordinates of visitor communication device 223, and the like. Application(s) 224 can be any software/hardware that can provide contact information and/or location information about the visitor to visitor register 111.

An unregistered visitor(s) comes to a site. Contact information and location information associated with the unregistered visitor(s) is registered by visitor register 111 and stored in emergency database 114. For example, visitor register 111 can automatically detect and register contact information and/or location information by receiving the contact information and the location information from application 224. The contact information and/or location information can be sent wirelessly to visitor register 111 by application 224 or using other known means of exchanging information. The contact information and/or location information can be sent based on an approval by the visitor. In one embodiment, the location information can be visitor calendar information (visitor contact/location information 225) that can include the visitor's schedule at the site.

In another embodiment, the contact information and/or location information 225 can be based on a notification from social network 221. Many social network(s) 221 can generate notifications (e.g., based on a registration). Social network 221 can be a visitor registration site where the visitor enters his/her contact information and/or location information. In this example, the visitor is a member of social network 221 and has posted location information and contact information about his/her scheduled visit, which generates a notification that is sent to social network monitor 216. Social network monitor 216 can parse the contact information and/or location information into a form that can be used by visitor register 111 and emergency database 114. Social network monitor 216 can strip off unnecessary information that is not important to locating or contacting the visitor or other contacts. Social network monitor 216 sends the contact information and/or location information to visitor register 111. The contact information from social network 221 can also include information that social network monitor 216 has mined by searching social network 221 for posts by the visitor (i.e., when it is known that the visitor is coming to visit the site). The contact information is registered and stored in emergency database 114.

In the above examples, the contact information and location information are described as coming from a single source and at the same time. However, the contact information and location information may come from different sources and may be gathered at different times. For example, the contact information may come from social network 221 prior to the visitor's arrival at the site. The location information can be provided by the user at check-in and then can be continually updated to emergency database 114; one way to accomplish this is by visitor communication device 223 constantly providing GPS coordinates to visitor register 111. The location information can be further updated when the visitor checks-out.

Emergency detector 112 detects an emergency at the site. Notification system 113 notifies the visitor(s) and/or other contact(s) based on the contact information and the location information. For example, notification system 113 can notify the visitor based on a provided email address or Instant Message (IM) address of the visitor by sending an email and/or IM to visitor communication device 223 based on location information that the visitor has checked-in. In a different embodiment, the notification could be a call to an emergency contact of the visitor at communication device 130A. In yet another example, the detected emergency can be an illness by the visitor and the notification is sending an email to the emergency responders (another contact) that the visitor is allergic to specific medicines. The above examples describe single notifications being sent. However, multiple notifications can be sent to the visitor and/or other contacts based on the same emergency.

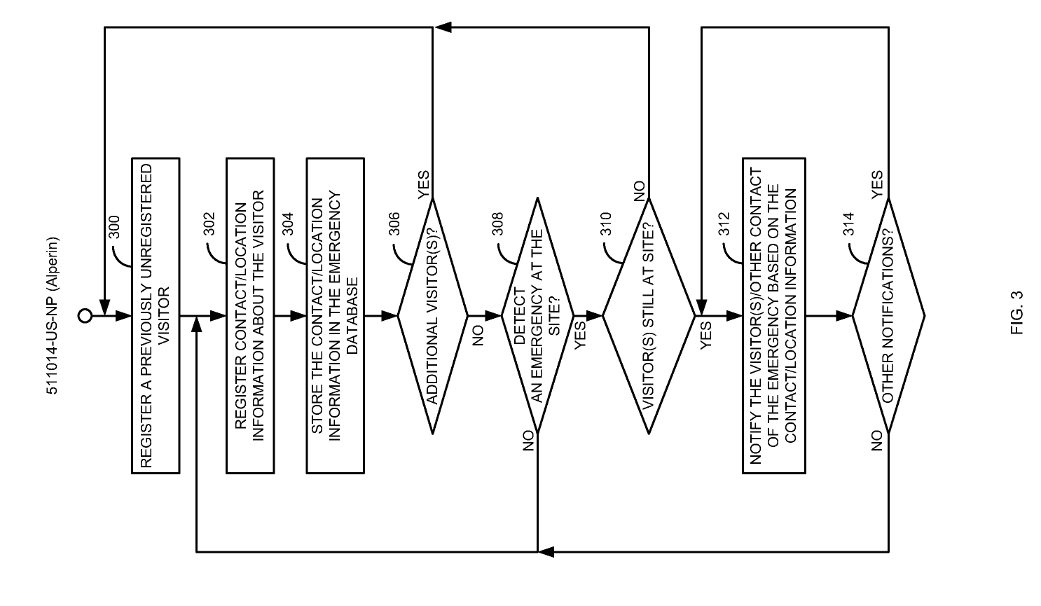

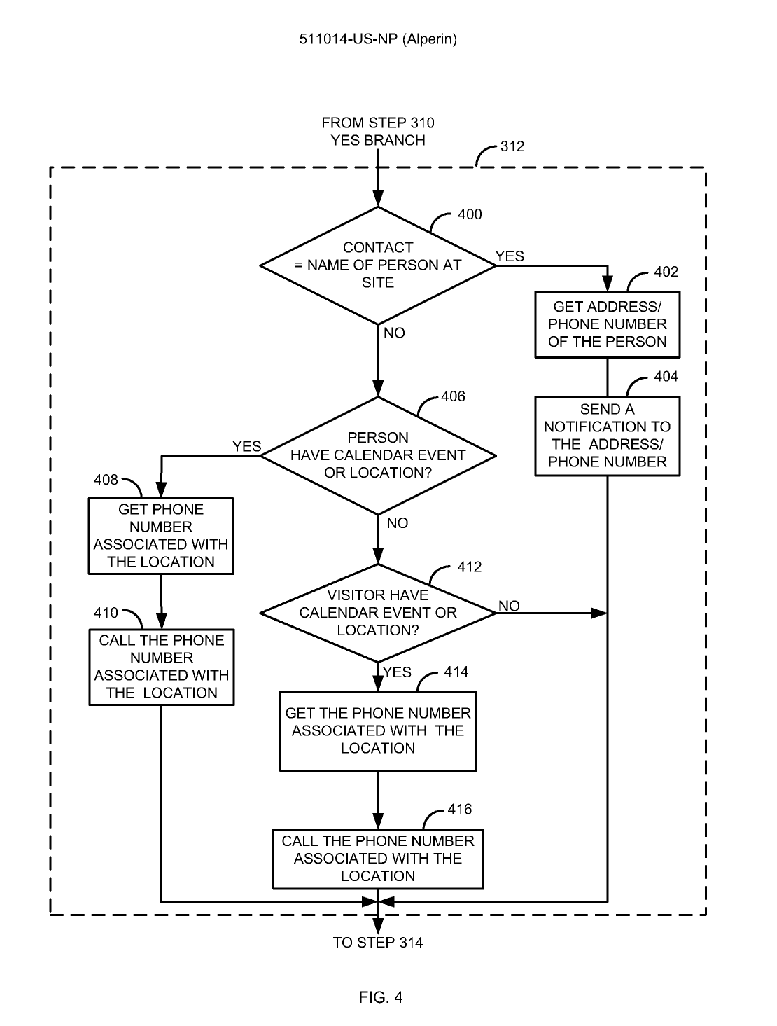

FIG. 3 is a flow diagram of a method for registering contact information and location information about a visitor and notifying the visitor and/or another contact in an emergency based on the location information. Illustratively, visitor register 111, emergency detector 112, notification system 113, local person contact/location information 215, social network monitor 216, social network 221, visitor communication device 223, visitor contact/location information 225, application 224, and communication devices 130A and 130B are stored-program-controlled entities, such as a computer or processor, which performs the method of FIGS. 3-4 and the processes described herein by executing program instructions stored in a tangible computer readable storage medium, such as a memory or disk.

Visitor register 111 registers 300 a previously unregistered visitor. Visitor register 111 registers 302 contact information and/or location information about the visitor. The registered contact information and/or location information can be based on a notification from social network 221, from application 224, based on information provided by the visitor, and the like.

Visitor register 111 stores 304 the contact information and/or the location information in emergency database 114. Visitor register 111 determines in step 306 if there are additional visitors to register. If there are additional visitors to register in step 306, the process goes to step 300. Otherwise, if there are not any additional visitors to register in step 306, emergency detector 112 determines in step 308 if there is an emergency at the site. If there is not an emergency at the site in step 308, the process goes to step 302 to register any additional or changing contact/location information (e.g., updates to the GPS location of the visitor).

If there is an emergency at the site in step 308, visitor register 111 determines if any visitors are still at the site in step 310. If there are not any visitors still at the site in step 310, the process goes to step 300. Otherwise, if there are one or more visitors still at the site in step 310, the visitor(s) and/or other contact(s) are notified 312 by notification system 113 based on the contact and location information. Determining if one or more visitors are still at the site can be based on location information that indicates a duration of the visit by the visitor(s), based on a visitor checking in but not checking out, based on the visitor checking in at a new location not associated with the site (possibly culled from social network inferences and notifications), based on calendar events, and the like. Notification system 113 determines if there are additional notifications in step 314. After the initial notification, notification system 113 can send additional notifications in various mediums to additional contacts or in additional mediums to the same contact. If there are other notifications in step 314, the process goes to step 312 to send the additional notifications. Otherwise, the process goes to step 302.

The method described in FIG. 3 is shown as a sequential process. However, the process of FIG. 3 can be implemented in various ways that would be obvious to one of ordinary skill in the art, such as providing separate threads for the visitor registration process and the emergency detection process.

FIG. 4 is a flow diagram of an exemplary method for notifying visitors and/or emergency contacts based on different kinds of contact information. FIG. 4 is an expanded view of step 312 in FIG. 3. After determining that visitors are at the site in step 310, notification system 113 determines in step 400 if the contact information is the name of a person at the site. If the contact information is the name of a person at the site in step 400, notification system 113 gets 402 the address(es)/phone number of the person from emergency database 114. An address can be an email address, an Instant Message (IM) address, a Universal Resource Locator (URL), and the like. Notification system 113 then notifies the visitor/person by calling/sending a notification to the person's address/phone number in step 404. In this example, step 404 is shown as going to step 314 for illustration purposes. However, step 404 could instead go to step 406 if additional contact information is to be used.

If notification system 113 determines that the contact information is not the name of a person at the site in step 400, notification system 113 determines in step 406 if the person who the visitor is visiting has a calendar event with location information or if the person has another type of location information. For example, the person at the site has a calendar event that is to take place in conference room ABC from 10:00 A.M. to 11:30 A.M. The emergency is at 10:45 A.M. In this example, notification system 113 identifies that the visitor is in conference room ABC at the time of the emergency by determining it from the calendar event. Other location information could be Global Positioning Satellite (GPS) information about the person (i.e., the person is in conference room ABC). Based on this information, notification system 113 gets 408 a phone number associated with the location (conference room ABC) from emergency database 114. Notification system 113 calls 410 the phone number associated with the location (conference room ABC). In this example, step 410 is shown as going to step 314 for illustration purposes. However, step 410 could instead go to step 412 if additional contact information is to be used.

If notification system 113 determines that the location information is not a calendar event or location of the person at the site in step 406, notification system 113 determines in step 412 if the contact information is a calendar event or location of the visitor. If the contact information is not a calendar event or location of the visitor in step 412, the process goes to step 314. Otherwise, if the contact information is a calendar event or location of the visitor in step 412, notification system 113 determines 414 the name of the person at the site from the visitor's calendar event or from a location associated with the person. Notification system 113 identifies the phone number associated with the location and calls 416 the person. For example, if the calendar event indicated that the visitor was going to be in the person's office, notification system 113 would call the person's office. The process goes to step 314.

As an alternative example, if the contact information is a calendar event of the visitor in step 412, notification system 113 can get 414 a phone number associated with the location (e.g., a conference room phone number). Notification system 113 can then call 416 the location.

The steps of detecting different events (400, 406, and 412) are shown in a specific order. However, these events can be accomplished in different orders that would be obvious to one of ordinary skill in the art.

Herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Herein, the term “a,” “an,” or another entity refers to one or more of that entity. As such, the terms “a” (or “an”), “one or more” and “at least one” can be used interchangeably herein. It is also to be noted that the terms “comprising,” “including,” and “having” can be used interchangeably.

Of course, various changes and modifications to the illustrative embodiment described above will be apparent to those skilled in the art. These changes and modifications can be made without departing from the spirit and the scope of the system and method and without diminishing its attendant advantages. The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
registering at a visitor register, contact information and location information about a previously unregistered visitor to a site, wherein the contact information comprises contact information associated with the visitor and/or another contact and the location information comprises location information associated with the visitor;
storing the contact information and the location information in an emergency database;
detecting by an emergency detector, an emergency at the site; and
notifying by a notification system, the visitor and/or the other contact of the emergency based on the location information.

2. The method of claim 1, wherein the contact information is at least one of the following: a phone number of the visitor, an email address of the visitor, and an Instant Message (IM) address of the visitor.

3. The method of claim 1, wherein the contact information is a name of a person at the site and the notifying step comprises calling a phone number associated with the person at the site.

4. The method of claim 1, wherein the contact information is a name of a person at the site, the location information is a calendar event of the person at the site that identifies a location at the site, and the notifying step comprises calling a phone number associated with the location at the site.

5. The method of claim 1, wherein the location information is a calendar event of the visitor, the contact information is a name of a person at the site that is determined from the calendar event of the visitor, and the notifying step comprises calling a phone number associated with the person at the site.

6. The method of claim 1, wherein the location information is a calendar event of the visitor, the location information is a location at the site that is determined from the calendar event of the visitor, and the notifying step comprises calling a phone number associated with the location at the site.

7. The method of claim 1, wherein the registering step is accomplished based on a notification from a social network or mining the social network.

8. The method of claim 1, wherein the registering step comprises receiving the contact information from an application.

9. The method of claim 8, wherein the contact information is registered based on an approval from the visitor and the application is automatically detected when the user enters the site.

10. The method of claim 1, wherein the location information is at least one of the following: a GPS location, a check-in by the visitor, a time duration of a visit by the visitor, and a wi-fi triangulation.

11. A system comprising:
a visitor register configured to register contact information and location information about an unregistered visitor to a site, wherein the contact information comprises contact information associated with the visitor and/or another contact and the location information comprises location information associated with the visitor;
an emergency database configured to store the contact information and the location information;
an emergency detector configured to detect an emergency at the site; and
a notification system configured to notify the visitor and/or the another contact of the emergency based on the location information.

12. The system of claim 10, wherein the contact information is at least one of the following: a phone number of the visitor, an email address of the visitor, and an Instant Message (IM) address of the visitor.

13. The system of claim 10, wherein the contact information is a name of a person at the site and notifying comprises calling a phone number associated with the person at the site.

14. The system of claim 10, wherein the contact information is a name of a person at the site, the location information is a calendar event of the person at the site that identifies a location at the site, and notifying comprises calling a phone number associated with the location at the site.

15. The system of claim 10, wherein the location information is a calendar event of the visitor, the contact information is a name of a person at the site that is determined from the calendar event of the visitor, and notifying comprises calling a phone number associated with the person.

16. The system of claim 10, wherein the location information is a calendar event of the visitor, the location information is a location at the site that is determined from the calendar event of the visitor, and notifying comprises calling a phone number associated with the location at the site.

17. The system of claim 10, wherein registering is accomplished based on a notification from a social network or mining the social network.

18. The system of claim 10, wherein registering comprises receiving the contact information from an application.

19. The system of claim 18, wherein the contact information is received based on an approval from the visitor and the application is automatically detected when the user enters the site.

20. The system of claim 10, wherein the location information is at least one of the following: a GPS location, a check-in by the visitor, a time duration of a visit by the visitor, and a wi-fi triangulation.
